(19) United States
(12) Patent Application Publication
(10) Pub. No.: US 2026/0245292 A1
(43) Pub. Date: Aug. 20, 2026

(54) APPARATUS FOR GENERATING 360-DEGREE PANORAMIC IMAGE AND METHOD THEREOF

(71) Applicant: Bucketplace Co., Ltd., Seoul (KR)

(72) Inventors: Hyo Won HA, Daejeon (KR); Jae Heung SURH, Seoul (KR); Hyun Su KIM, Yongin-si (KR)

(73) Assignee: Bucketplace Co., Ltd., Seoul (KR)

(21) Appl. No.: 19/449,529

(22) Filed: Jan. 15, 2026

(30) Foreign Application Priority Data
Feb. 14, 2025 (KR) 10-2025-0019373

(51) Int. Cl. G06T 15/20; G06T 3/16; G06T 3/20; G06T 3/60; G06T 5/77; G06T 5/80; G06T 7/80; G06T 7/90; G06T 15/04

(52) U.S. Cl. CPC G06T 15/20; G06T 3/16; G06T 3/20; G06T 3/60; G06T 5/77; G06T 5/80; G06T 7/80; G06T 7/90; G06T 15/04; G06T 2207/10024; G06T 2207/10028; G06T 2207/20081; G06T 2215/16

(57) ABSTRACT

Disclosed are an apparatus for generating a 360-degree panoramic image and a method thereof. More particularly, an apparatus for generating a 360-degree panoramic image according to an embodiment of the present disclosure includes: a depth data processor configured to process resolution-related sampling using a color image for depth data of images acquired from a single camera stream through a camera, and construct a depth map based on a deep learning model; an error correction processor configured to determine a virtual panoramic viewpoint considering different camera poses of the images, splat the images into a panoramic image space based on the depth map of each of the images, derive a Global Color Correction (GCC) parameter, related to color value correction of the splatted images, and a residual pose parameter related to a pose variation amount, and correct the GCC parameter and the residual pose parameter by calculating at least one loss function for the splatted images; and a panorama processor configured to re-splat images, to which corrected GCC parameter and the corrected residual pose parameter are applied, into the panoramic image space; stitch the re-splatted images, perform local color correction on overlapping regions in the stitched images, and perform seam blending to generate a panoramic image.

### CROSS-REFERENCE TO RELATED APPLICATION

This application claims priority to Korean Patent Application No. 10-2025-0019373, filed on Feb. 14, 2025 in the Korean Intellectual Property Office, the disclosure of which is incorporated herein by reference.

### BACKGROUND OF THE DISCLOSURE

### Field of the Disclosure

The present disclosure relates to an apparatus for generating a 360-degree panoramic image and a method thereof, and more specifically, to a technology for achieving alignment of a 360-degree panoramic image through 3D image splatting using depth and camera pose optimization.

### Description of the Related Art

Generally, a method of applying geometric alignment after performing feature point matching on images obtained from two or more cameras based on an epipolar line is used to align images.

However, conventional image alignment methods not based on deep learning have a problem of relying on feature point matching and energy minimization in every alignment process. The feature point matching method is not as robust as a deep learning-based feature map extraction method, and if the feature point matching fails, the entire algorithm can lead to failure.

In addition, since the conventional image alignment method requires performing energy function optimization in calculations for local homography estimation, optimal epipolar line estimation, and 2D transformation selection for each image, there is a problem that the computational complexity of the algorithm increases significantly, making it difficult to align high-resolution panoramic images in real time.

Korean Patent Application Publication No. 10-2023-0043668, introduced as prior art, proposes a configuration that increases an image alignment success rate even under adverse conditions, such as the brightness, contrast, color change, low image quality, and small overlapping areas of an image, by extracting features using a deep learning network.

However, since this prior art is a configuration for processing images obtained simultaneously from a plurality of cameras, there is a problem that a plurality of cameras are required.

In addition, since the prior art achieves only visual alignment by distorting an image in a 2-dimensional domain, there is a limitation that a distortion problem occurs in the generated panoramic image.

### SUMMARY OF THE DISCLOSURE

Therefore, the present disclosure has been made in view of the above problems, and it is an object of the present disclosure to provide an apparatus for generating a 360-degree panoramic image to achieve alignment of a 360-degree panoramic image through 3D image splatting using depth and camera pose optimization and a method thereof.

It is another object of the present disclosure to generate a panoramic image with secured physical accuracy which is capable of measuring a size of a space or implementing an experience such as Augmented Reality (AR), while achieving alignment of a 360-degree panoramic image.

It is still another object of the present disclosure to provide an apparatus for generating a 360-degree panoramic image which can generate a 360-degree panoramic image by shooting with a mobile phone, which is a general user terminal, without special equipment such as a 360-degree camera, and a method thereof.

It is yet another object of the present disclosure to achieve natural image implementation in a panoramic area by deleting some internal components and then inpainting the same in an application program implementation for generating a 360-degree panoramic image.

In accordance with an aspect of the present disclosure, the above and other objects can be accomplished by the provision of an apparatus for generating a 360-degree panoramic image, the apparatus including: a depth data processor configured to process resolution-related sampling using a color image for depth data of images acquired from a single camera stream through a camera, and construct a depth map based on a deep learning model; an error correction processor configured to determine a virtual panoramic viewpoint considering different camera poses of the images, splat the images into a panoramic image space based on the depth map of each of the images, derive a Global Color Correction (GCC) parameter, related to color value correction of the splatted images, and a residual pose parameter related to a pose variation amount, and correct the GCC parameter and the residual pose parameter by calculating at least one loss function for the splatted images; and a panorama processor configured to re-splat images, to which corrected GCC parameter and the corrected residual pose parameter are applied, into the panoramic image space; stitch the re-splatted images, perform local color correction on overlapping regions in the stitched images, and perform seam blending to generate a panoramic image.

The error correction processor may back-project a pixel of each of the images into a 3D point based on the depth map, transform the 3D point from an image coordinate system to a world coordinate system and from the world coordinate system to a panoramic coordinate system, project the 3D point into the panoramic image space to calculate coordinates, map the pixel to a panorama pixel, and splat the images into the panoramic image space based on the calculated pixel mapping.

The error correction processor may calculate at least one loss function among a photometric consistency loss, a gradient consistency loss, a depth consistency loss, and a feature anchoring loss in relation to the GCC parameter with respect to the splatted images, and calculate at least one loss function among a rotation regularizer loss, a translation regularizer loss, and a GCC regularizer loss in relation to the residual pose parameter.

The error correction processor may calculate a total loss based on a sum of the at least one loss function, and correct the GCC parameter and the residual pose parameter by setting a weight for each of the at least one loss function such that the calculated total loss is minimized.

The error correction processor may calculate the photometric consistency loss based on a sum of losses relative to individual color values after calculating an average color value for all pixels where the splatted images overlap each other on the panoramic image space; calculate the gradient consistency loss based on a sum of losses relative to individual gradient values after deriving gradient images for the images to splat the gradient images, and then calculating an average gradient value for all pixels overlapping each other; calculate the depth consistency loss based on a sum of losses relative to individual values after calculating an average depth value using a reciprocal of a distance calculated when projecting back-projected 3D points into the panoramic image space; and calculate the feature anchoring loss based on feature extraction and matching.

The error correction processor may calculate the rotation regularizer loss based on a sum of losses between a rotation matrix of a residual pose of each of the images and an identity matrix; calculate the translation regularizer loss based on a sum of losses between a translation vector of the residual pose of each of the images and a zero vector; and calculate the GCC regularizer loss based on a sum of losses between a color correction matrix of each of the images and a truncated identity matrix.

The panorama processor may derive a pixel value for the splatted images, measure a depth of 3D points for the derived pixel value, select images to be used for the generated panoramic image from among the splatted images based on the measured depth, and perform the local color correction to correct a color difference for an overlapping area in the selected images.

The panorama processor may perform the seam blending to correct a color difference for a boundary part within the generated panoramic image by correcting a color, which has been corrected after the local color correction, using a residual color related to a gradient of the image.

According to an embodiment of the present disclosure, the apparatus may further include an application processor configured to select at least one object in the panoramic image, delete the selected at least one object to process it into an Augmented Reality (AR) plane, and restore the processed AR plane into the panoramic image.

The application processor may perform processing into the AR plane by performing orthographic projection of a texture of the panoramic image onto each plane and then performing inpainting on a part detected as a foreground area in each plane.

In accordance with another aspect of the present disclosure, provided is a method of generating a 360-degree panoramic image, the method including: by a depth data processor, processing resolution-related sampling using a color image for depth data of images acquired from a single camera stream through a camera, and constructing a depth map based on a deep learning model; by an error correction processor, determining a virtual panoramic viewpoint considering different camera poses of the images, splatting the images into a panoramic image space based on the depth map of each of the images, deriving a Global Color Correction (GCC) parameter, related to color value correction of the splatted images, and a residual pose parameter related to a pose variation amount, and correcting the GCC parameter and the residual pose parameter by calculating at least one loss function for the splatted images; and by a panorama processor, re-splatting images, to which corrected GCC parameter and the corrected residual pose parameter are applied, into the panoramic image space; stitching the re-splatted images, performing local color correction on overlapping regions in the stitched images, and performing seam blending to generate a panoramic image.

The determining of a virtual panoramic viewpoint considering different camera poses of the images, the splatting of the images into a panoramic image space based on the depth map of each of the images, the deriving of a Global Color Correction (GCC) parameter, related to color value correction of the splatted images, and a residual pose parameter related to a pose variation amount, and the correcting of the GCC parameter and the residual pose parameter by calculating at least one loss function for the splatted images, by the error correction processor may include: back-projecting a pixel of each of the images into a 3D point based on the depth map, transforming the 3D point from an image coordinate system to a world coordinate system and from the world coordinate system to a panoramic coordinate system, projecting the 3D point into the panoramic image space to calculate coordinates to map the pixel to a panorama pixel, and splatting the images into the panoramic image space based on the calculated pixel mapping; calculating at least one loss function among a photometric consistency loss, a gradient consistency loss, a depth consistency loss, and a feature anchoring loss in relation to the GCC parameter with respect to the splatted images, and calculating at least one loss function among a rotation regularizer loss, a translation regularizer loss, and a GCC regularizer loss in relation to the residual pose parameter; and calculating a total loss based on a sum of the at least one loss function, and correcting the GCC parameter and the residual pose parameter by setting a weight for each of the at least one loss function such that the calculated total loss is minimized.

The calculating of at least one loss function among a photometric consistency loss, a gradient consistency loss, a depth consistency loss, and a feature anchoring loss in relation to the GCC parameter with respect to the splatted images, and the calculating of at least one loss function among a rotation regularizer loss, a translation regularizer loss, and a GCC regularizer loss in relation to the residual pose parameter may include: calculating the photometric consistency loss based on a sum of losses relative to individual color values after calculating an average color value for all pixels where the splatted images overlap each other on the panoramic image space; calculating the gradient consistency loss based on a sum of losses relative to individual gradient values after deriving gradient images for the images to splat the gradient images, and then calculating an average gradient value for all pixels overlapping each other; calculating the depth consistency loss based on a sum of losses relative to individual values after calculating an average depth value using a reciprocal of a distance calculated when projecting back-projected 3D points into the panoramic image space; and calculating the feature anchoring loss based on feature extraction and matching.

The calculating of at least one loss function among a photometric consistency loss, a gradient consistency loss, a depth consistency loss, and a feature anchoring loss in relation to the GCC parameter with respect to the splatted images, and the calculating of at least one loss function among a rotation regularizer loss, a translation regularizer loss, and a GCC regularizer loss in relation to the residual pose parameter may include: calculating the rotation regularizer loss based on a sum of losses between a rotation matrix of a residual pose of each of the images and an identity matrix; calculating the translation regularizer loss based on a sum of losses between a translation vector of a residual pose of each of the images and a zero vector; and calculating the GCC regularizer loss based on a sum of losses between a color correction matrix of each of the images and a truncated identity matrix.

The re-splatting of images, to which corrected GCC parameter and the corrected residual pose parameter are applied, into the panoramic image space; the stitching of the re-splatted images, the performing of local color correction on overlapping regions in the stitched images, and the performing of seam blending to generate a panoramic image may include: deriving a pixel value for the splatted images, measuring a depth of 3D points for the derived pixel value, selecting images, to be used for the generated panoramic image, from among the splatted images based on the measured depth, and performing the local color correction to correct a color difference for an overlapping area in the selected images; and performing the seam blending to correct a color difference for a boundary part within the generated panoramic image by correcting a color, which has been corrected after the local color correction, using a residual color related to a gradient of the image.

According to an embodiment of the present disclosure, the method may further include selecting, by an application processor, at least one object in the panoramic image, deleting the selected at least one object to process it into an Augmented Reality (AR) plane, and restoring the processed AR plane into the panoramic image.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating an apparatus for generating a 360-degree panoramic image according to an embodiment of the present disclosure;

FIG. 2 is a set of diagrams illustrating a screen for generating a 360-degree panoramic image according to an embodiment of the present disclosure;

FIG. 3 is a set of diagrams illustrating image splatting for generating a 360-degree panoramic image according to an embodiment of the present disclosure;

FIG. 4 is a set of diagrams illustrating camera pose optimization for generating a 360-degree panoramic image according to an embodiment of the present disclosure;

FIGS. 5A and 5B are diagrams illustrating a configuration of frame selection-based preprocessing and local color correction for generating a 360-degree panoramic image according to an embodiment of the present disclosure;

FIG. 6 is a diagram illustrating a seam blending configuration for generating a 360-degree panoramic image according to an embodiment of the present disclosure;

FIG. 7 is a diagram illustrating a panorama inpainting configuration related to a 360-degree panoramic image application according to an embodiment of the present disclosure; and

FIG. 8 is a diagram illustrating a method of generating a 360-degree panoramic image according to an embodiment of the present disclosure.

### DETAILED DESCRIPTION OF THE DISCLOSURE

Specific structural and functional descriptions of embodiments according to the concept of the present disclosure disclosed herein are merely illustrative for the purpose of explaining the embodiments according to the concept of the present disclosure. Furthermore, the embodiments according to the concept of the present disclosure can be implemented in various forms and the present disclosure is not limited to the embodiments described herein.

The embodiments according to the concept of the present disclosure may be implemented in various forms as various modifications may be made. The embodiments will be described in detail herein with reference to the drawings. However, it should be understood that the present disclosure is not limited to the embodiments according to the concept of the present disclosure, but includes changes, equivalents, or alternatives falling within the spirit and scope of the present disclosure.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the scope of rights according to the concept of the present invention.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Other words used to describe the relationship between elements should be interpreted in a like fashion (e.g., “between,” versus “directly between,” “adjacent,” versus “directly adjacent,” etc.).

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” in the specification should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure will now be described more fully with reference to the accompanying drawings, in which exemplary embodiments of the disclosure are shown. This disclosure may, however, be embodied in many different forms and should not be construed as limited to the exemplary embodiments set forth herein. Like reference numerals in the drawings denote like elements.

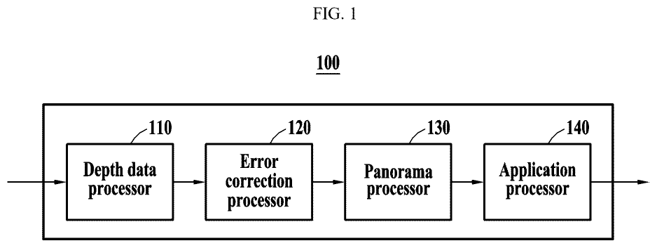

FIG. 1 is a diagram illustrating an apparatus for generating a 360-degree panoramic image according to an embodiment of the present disclosure.

FIG. 1 illustrates components of the apparatus for generating a 360-degree panoramic image according to an embodiment of the present disclosure.

Referring to FIG. 1, an apparatus 100 for generating a 360-degree panoramic image according to an embodiment of the present disclosure includes a depth data processor 110, an error correction processor 120 and a panorama processor 130.

The apparatus 100 for generating a 360-degree panoramic image according to an embodiment of the present disclosure may generate a 360-degree panoramic image by capturing images using a mobile phone without special equipment such as a 360-degree camera.

As an example, the apparatus 100 for generating a 360-degree panoramic image may achieve alignment through 3-dimensional (3D) image splatting using depth and camera pose optimization, and using a result thereof, may generate a panoramic image having physical accuracy to measure the size of a space or implement an experience such as augmented reality.

For example, the depth is based on depth data acquired through a LiDAR sensor included in a mobile camera.

The depth data processor 110 according to an embodiment of the present disclosure may process resolution-related sampling using a color image for depth data of images acquired from a single camera stream through a camera, and construct a depth map based on a deep learning model.

As an example, the depth data processor 110 adjusts the resolution to match the color image by performing an up-sampling technique utilizing the color image as guidance.

The depth data processor 110 utilizes a deep learning network as a backbone of the deep learning model, creates training data in consideration of characteristics of data obtained from a mobile, and performs model training.

For example, the depth data processor 110 may obtain corresponding depth maps by applying a commercial Monocular Depth Estimation (MDE) method to various types of color images.

The depth data processor 110 considers inaccuracy inherent in LiDAR depth data using the inaccurate depth estimated by the MDE method.

The depth data processor 110 obtains a low-resolution depth map by down-sampling each depth map, obtained by MDE, by 8 times using a nearest neighbor method.

The depth data processor 110 may proceed with training by configuring a dataset with pairs of high-resolution depth maps and low-resolution depth maps.

The error correction processor 120 according to an embodiment of the present disclosure may determine a virtual panoramic viewpoint considering different camera poses of the images, splat the images into a panoramic image space based on the depth map of each of the images, derive a Global Color Correction (GCC) parameter, related to color value correction of the splatted images, and a residual pose parameter related to a pose variation amount, and correct the GCC parameter and the residual pose parameter by calculating at least one loss function for the splatted images.

As an example, the error correction processor 120 may back-project pixels of each of the images into 3D points based on the depth map, convert the 3D points from an image coordinate system to a world coordinate system and from the world coordinate system to a panoramic coordinate system, calculate coordinates by projecting the 3D points into the panoramic image space to calculate pixel-to-panoramic pixel mapping, and splat the images into the panoramic image space based on the calculated pixel mapping.

According to an embodiment of the present disclosure, the error correction processor 120 may calculate at least one loss function among a photometric consistency loss, a gradient consistency loss, a depth consistency loss, and a feature anchoring loss related to the GCC parameter with respect to the splatted images, and calculate at least one loss function among a rotation regularizer loss, a translation regularizer loss, and a GCC regularizer loss related to the residual pose parameter.

As an example, the error correction processor 120 may calculate a total loss based on a sum of the at least one loss function, and correct the GCC parameter and the residual pose parameter by setting a weight to each of the at least one loss function so that the calculated total loss is minimized.

The error correction processor 120 according to an embodiment of the present disclosure may calculate the photometric consistency loss based on a sum of losses with individual color values after calculating an average color value for all pixels where the splatted images overlap each other on the panoramic image space; derive a gradient image for the images to splat the gradient image, and then calculate an average gradient value for all overlapping pixels, and then calculate the gradient consistency loss based on a sum of losses with individual gradient values; calculate an average depth value using a reciprocal of a calculated distance when projecting back-projected 3D points onto the panoramic image space, and then calculate the depth consistency loss based on a sum of losses relative to individual values, and calculate the feature anchoring loss based on feature extraction and matching.

As an example, the error correction processor 120 may calculate the rotation regularizer loss based on a sum of losses between a rotation matrix of the residual pose of each of the images and an identity matrix; calculate the translation regularizer loss based on a sum of losses between a translation vector of the residual pose of each of the images and a zero vector; and calculate the GCC regularizer loss based on a sum of losses between a color correction matrix of each of the images and a truncated identity matrix.

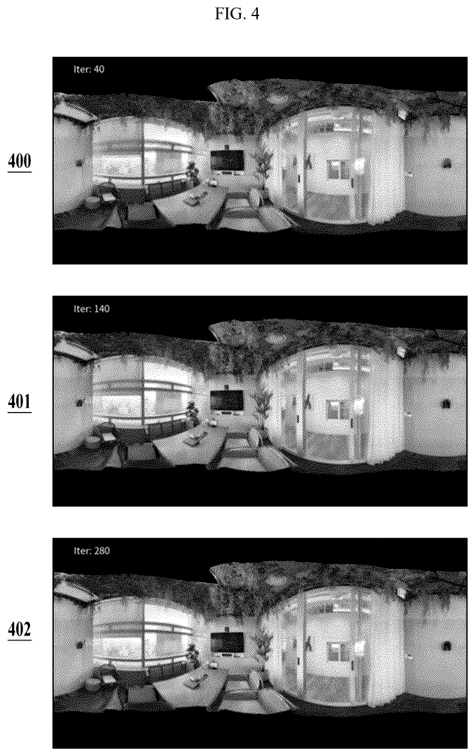

For example, a configuration of GCC and camera pose optimization using a loss function based on the error correction processor 120 will be described in more detail with reference to FIG. 4.

The panorama processor 130 according to an embodiment of the present disclosure may re-splat images, to which corrected GCC parameter and the corrected residual pose parameter are applied, into the panoramic image space; stitch the re-splatted images, perform local color correction on overlapping regions in the stitched images, and perform seam blending to generate a panoramic image.

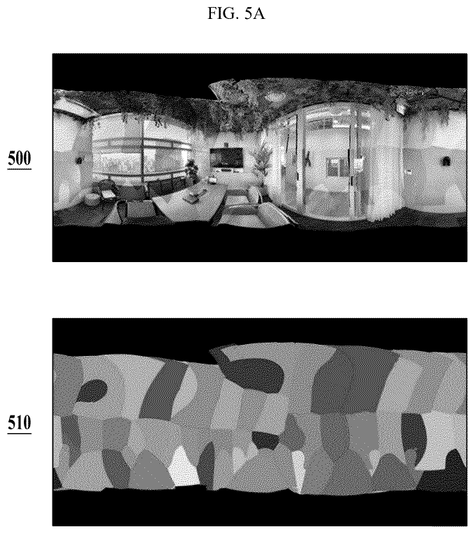

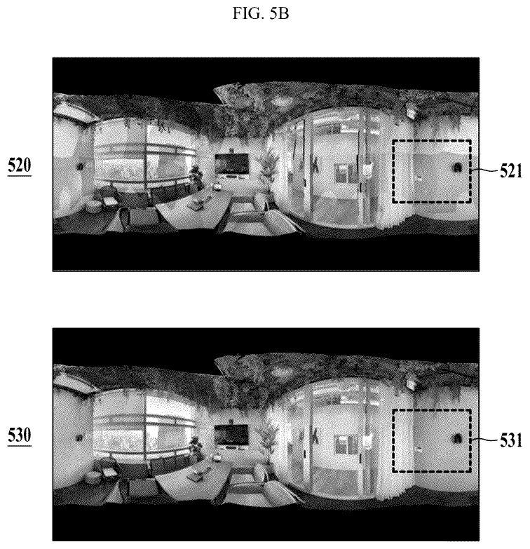

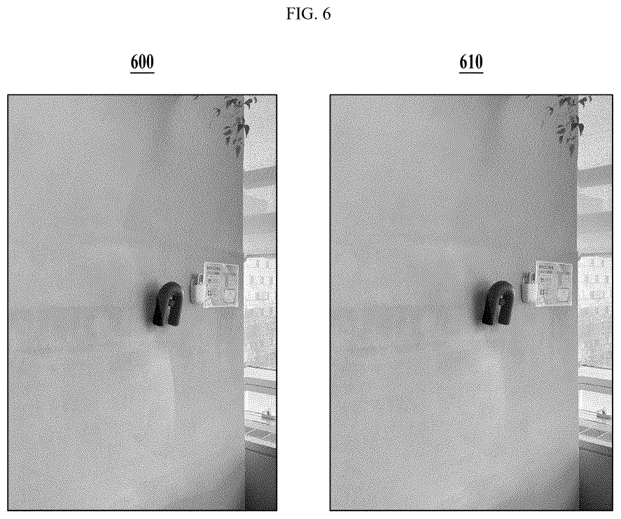

The local color correction based on the panorama processor 130 will be described in more detail with reference to FIGS. 5A and 5B, and the seam blending will be described in more detail with reference to FIG. 6.

As an example, the panorama processor 130 may derive pixel values for the splatted images, measure a distance between 3D points for the derived pixel values, select images, to be used for the generated panoramic image, from among the splatted images based on the measured distance, and perform the local color correction for correcting a color difference for an overlapping region in the selected images.

The panorama processor 130 according to an embodiment of the present disclosure may perform seam blending to correct a color difference for a boundary portion in the generated panoramic image by correcting a color, corrected after local color correction, using a residual color related to a gradient of an image.

The apparatus 100 for generating a 360-degree panoramic image according to an embodiment of the present disclosure further includes an application processor 140.

According to an embodiment of the present disclosure, the application processor 140 may select at least one object in the panoramic image, delete the selected at least one object to process the image into an Augmented Reality (AR) plane, and restore the processed AR plane to the panoramic image.

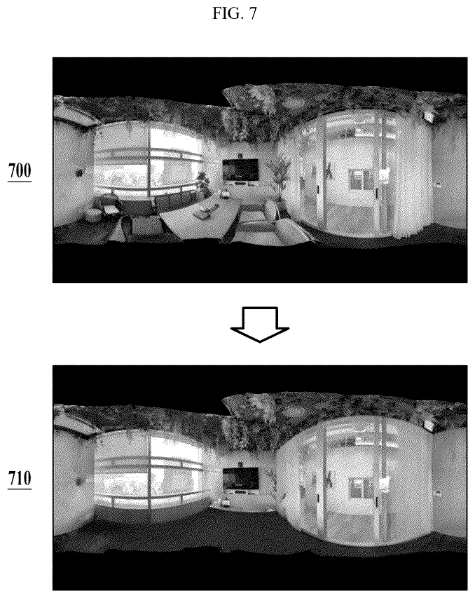

The application processor 140 may perform orthographic projection of a texture of the panoramic image onto each plane, and then perform inpainting on a portion detected as a foreground region to process the image into the AR plane. Here, the inpainting based on the application processor 140 will be described in more detail with reference to FIG. 7.

Accordingly, the present disclosure may provide an apparatus for generating a 360-degree panoramic image to achieve alignment of a 360-degree panoramic image through 3D image splatting using depth and camera pose optimization, and a method thereof.

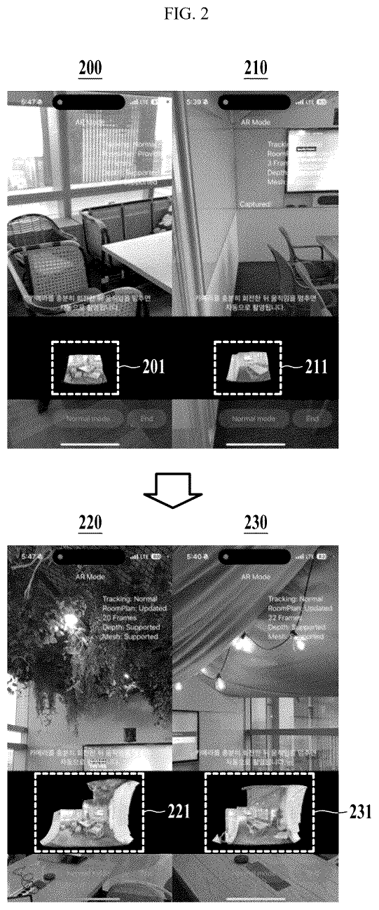

FIG. 2 is a set of diagrams illustrating a screen for generating a 360-degree panoramic image according to an embodiment of the present disclosure.

FIG. 2 illustrates screens for generating a 360-degree panoramic image according to an embodiment of the present disclosure.

Referring to FIG. 2, an image 200 and an image 220 are continuous screens, and an image 210 and an image 230 are continuous screens.

The image 200 splats a screen, captured by a mobile camera, as an image 201 onto a panoramic image space.

The image 210 splats a screen, captured by a mobile camera, as an image 211 onto a panoramic image space.

The image 220 splats a screen, captured by a mobile camera, as an image 221 onto a panoramic image space.

The image 230 splats a screen, captured by a mobile camera, as an image 231 onto a panoramic image space.

Comparing the image 201 with the image 221, it can be confirmed that the captured images are cumulatively added.

Comparing the image 211 with the image 231, it can be confirmed that the captured images are cumulatively added.

An image may be automatically captured when moving by a certain angle or more from a previous image and satisfying a sharpness condition.

Images may be captured such that an overlap of at least about ⅓ occurs between adjacent images.

The image 201, the image 211, the image 221, and the image 231 may be preview images.

The image 201, the image 211, the image 221, and the image 231 show capturing only one side of a space, but actually, the entire 360 degrees in a horizontal direction may be captured.

For example, a user captures a plurality of images by positioning the camera close to a body at a point where a 360-degree panoramic image is to be generated, and captures the plurality of images while slowly moving in a zigzag manner to cover 120 to 180 degrees vertically and 180 to 360 degrees horizontally so that there are no empty spaces.

In this case, the less a physical position of the camera moves, the higher quality panoramic image may be generated.

Poses of the captured images and internal camera parameters are simultaneously recorded, and visual feedback may be provided on the screen to allow the user to capture images evenly while recognizing an already captured area during shooting.

When the shooting is completed, data is transmitted to a server and given to a panorama generation solution, and then a processed panoramic image may be provided to the user.

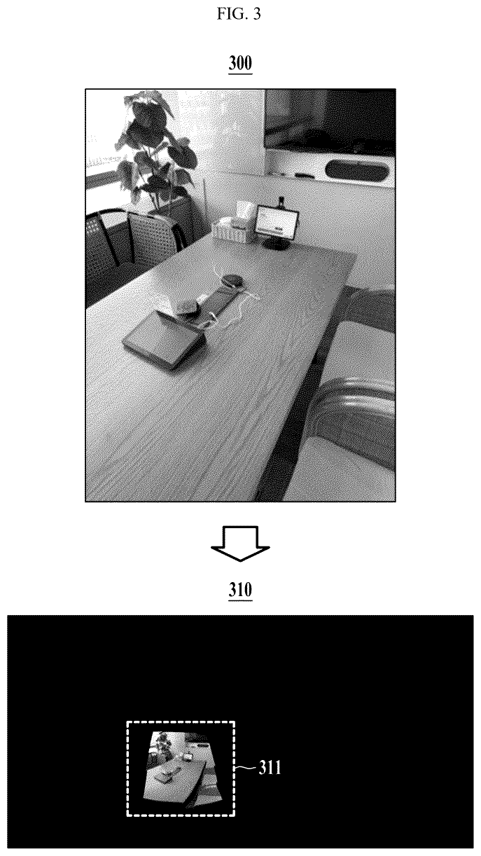

FIG. 3 is a set of diagrams illustrating image splatting for generating a 360-degree panoramic image according to an embodiment of the present disclosure.

FIG. 3 illustrates a result of image splatting for generating a 360-degree panoramic image according to an embodiment of the present disclosure.

Referring to FIG. 3, an image 300 represents a captured image, and an image 310 represents a panoramic image space.

In the image 310, a result of splatting the previously captured image 300 onto the panoramic space is shown as a preview image 311.

For the image 300 to be splatted onto the panoramic image space, errors exist in a camera pose for each image, so that correction for the error is required.

To splat the captured image onto the panoramic image space, a gradient descent-based optimization algorithm needs to be applied.

As a preliminary step, a virtual panoramic viewpoint capable of best encompassing images having N different poses may be determined.

After constructing 3D lines using camera positions and viewing directions of respective images, a point in space where a squared sum of Euclidean distances to all lines is minimized is calculated, and the point may be determined as a position of a virtual panoramic camera.

An axis direction of the panoramic camera is set such that a down direction matches a gravity direction, and a looking direction may be arbitrarily set since the camera covers all 360 degrees horizontally anyway.

Depth-based image splatting is applied in the present disclosure, wherein each input image is splatted into a panoramic image space based on a depth map.

The splatting of the present disclosure calculates image pixels via pixel-to-panoramic pixel mapping.

The splatting of the present disclosure calculates panoramic pixel mapping for image pixels.

Each pixel of the image is back-projected into a 3D point based on the depth map.

For example, it may be summarized as in Equation 1 below:

$${X}_{frame} = {{K}^{- 1} [ u , v , 1 ]}^{T} \cdot d \qquad [ Equation 1 ]$$

In Equation 1, X represents a back-projected 3D point in an image reference coordinate system, K represents a camera intrinsic matrix, u and v represent image coordinates, and d represents a depth value.

The 3D point is sequentially transformed from the image coordinate system to a world coordinate system and then to a panoramic coordinate system.

$${X}_{pano} = {T}_{w 2 p} \cdot {T}_{f 2 w} \cdot {X}_{frame} \qquad [ Equation 2 ]$$

In Equation 2, Xₚₐₙₒ represents a panoramic reference coordinate system of the 3D point, T_{w2p} represents a transformation from the world coordinate system to the panoramic coordinate system, and T_{f2w} represents a transformation from a frame coordinate system to the world coordinate system.

Coordinates may be calculated using Equation 3 below by projecting onto the panoramic image space.

$${[ x , y , z ]}^{T} = {X}_{pano} / \vert {X}_{pano} \vert , \\ {u}_{pano} = ( ( θ + π ) / 2 π * {W}_{pano} - 0.5 ) \% {W}_{pano} , \qquad [ Equation 3 ]$$

$$where θ = {tan}^{- 1} ( x / z ) ,$$

In Equation 3, Wₚₐₙₒ represents a panorama width, and % represents a modulo operation.

Coordinates may be calculated using Equation 4 below by projecting onto the panoramic image space.

$${v}_{pano} = ( ϕ + π / 2 ) / π * {H}_{pano} - 0.5 , \qquad [ Equation 4 ]$$

$$where ϕ = {sin}^{- 1} ( y )$$

In Equation 4, Hₚₐₙₒ represents a panorama height.

An arbitrarily set panorama size is applied based on Equations 3 and 4; for example, 1024 and 512 may be used, and 8192 and 4096 may be used in subsequent stitching.

The image is splatted into the panoramic image space based on mapping of image coordinates (u, v) for each pixel.

In this case, since the coordinates on the panoramic image space are floating-point (real number) coordinates, values to be splatted are weighted and then accumulated, using a scheme, similar to bilinear interpolation, for a 2×2 pixel area surrounding the corresponding coordinates.

FIG. 4 is a set of diagrams illustrating camera pose optimization for generating a 360-degree panoramic image according to an embodiment of the present disclosure.

FIG. 4 illustrates a result of camera pose optimization for generating a 360-degree panoramic image according to an embodiment of the present disclosure.

Referring to FIG. 4, results to which camera pose optimization is equentially applied are shown through an image 400, an image 401, and an image 402.

Global Color Correction (GCC) is applied to the image 400, the image 401, and the image 402.

GCC for adjusting RGB values is applied for each image, and an application result thereof may be defined as in Equation 5 below:

$${[ {r}^{′} , {g}^{′} , {b}^{′} ]}^{T} = {M}_{GCC} \cdot {[ r , g , b , 1 ]}^{T} \qquad [ Equation 5 ]$$

In Equation 5, [r′, g′, b′] represents a corrected color, M_{GCC} represents a color correction transformation, and [r, g, b] represents an intrinsic color.

Here, the color correction transformation is a unique 3*4 matrix for each image, in a form where color crosstalk and color offset are horizontally concatenated.

A residual pose representation related to the image 400, the image 401, and the image 402 may be represented by parameterizing a variation amount from a corresponding pose, and may be summarized as in Equation 6 below:

$${T}_{refined} = {T}_{orig} \cdot {T}_{residual} \qquad [ Equation 6 ]$$

In Equation 6, T_{refined} may represent a refined pose, T_{orig} may represent an original AR pose, and T_{residual} may represent a residual pose.

It is a rigid body transformation of an SE group; in the SE group, $R$ and $t$ are a rotation matrix and a translation vector, respectively, capable of representing 3 variables each.

T_{residual} is a rigid body transformation of the SE group, and the SE group is [R, t; 0, 0, 0, 1]. Here, R denotes a rotation matrix and t denotes a translation vector, each of which can be represented by 3 variables.

The error correction processor according to an embodiment of the present disclosure calculates a loss function and performs optimization to minimize loss.

In this case, variables subject to optimization are residual poses of all images and GCC parameters.

A sum of loss functions may be summarized as in Equation 7:

$${L}_{total} = {L}_{color} + {λ}_{gradient} {L}_{gradient} + {λ}_{depth} {L}_{depth} + {λ}_{anchor} {L}_{anchor} + {λ}_{rot . reg .} {L}_{rot . reg .} + {λ}_{trans . reg .} {L}_{trans . reg .} + {λ}_{gcc . reg .} {L}_{gcc . reg .} \qquad [ Equation 7 ]$$

In Equation 7, Lₜₒₜₐₗ represents a total loss function, L_{color} represents a photometric consistency loss, L_{gradient} represents a gradient consistency loss, L_{depth} represents a depth consistency loss, L_{anchor} represents a feature anchoring loss, L_{rot.reg} represents a rotation regularizer loss, L_{trans.reg} represents a translation regularizer loss, and L_{gcc.reg} represents a GCC regularizer loss.

The photometric consistency loss is obtained by calculating an average color value for all pixels where color images splatted on the panoramic space overlap each other, and then calculating a sum of L1 losses relative to individual color values.

It uses color values to which GCC is applied, and serves to guide overlapping parts to be matched with each other.

The reason for using a difference between an average value and individual values as a loss is that while direct comparison is sufficient if there are simply two overlapping images, there is a problem that the number of cases is too large to compare all of them pairwise if there are two or more images.

The gradient consistency loss is similar to the photometric consistency loss, but a gradient image of the color image is obtained in advance instead of the color image, and then splatting is performed in the same manner to calculate a sum of L1 losses between an average value and individual values.

It has an effect of further reinforcing alignment of parts with strong texture, and is highly effective in early stages of optimization where color correction is less complete due to characteristics robust to scale and offset differences caused by auto-exposure, etc.

The depth consistency loss does not directly splat a depth image, but uses a reciprocal calculated when projecting back-projected 3D points into the panoramic image space during a splatting process.

After calculating an average of the obtained depth values, a sum of L1 losses relative to individual values is calculated.

Using inverse depth allows for correcting errors at close points much more intensively than errors at distant points, which is advantageous for this matching method utilizing a perspective image space, and actually helps in obtaining good matching results.

The feature anchoring consistency loss is a loss function utilizing feature extraction and matching techniques frequently used in the vision field.

Feature extraction extracts feature points from each of N input images.

A method with high speed and high accuracy, such as XFeat [2], is preferred, but other methods may be used.

Feature matching returns a list of feature points matching each other for all image-image combinations (=N*(N−1)/2 cases).

By using a methodology such as LightGlue [3] (or more lightweight LighterGlue), reliable matching results may be obtained quickly.

Since complexity increases in proportion to N\hat{ }2 to perform for all image combinations, efficiency may be achieved by performing only for combinations where a difference in image pose is within a certain condition.

In the case of using only three local consistency losses, there may be a problem that corresponding points far apart initially fail to match. There is an anchoring effect that prevents this.

The rotation regularizer loss represents a sum of L2 losses between a rotation matrix of the residual pose of each image and an identity matrix, and penalizes the refined pose from rotating far from the original pose.

The translation regularizer loss represents a sum of L2 losses between a translation vector of the residual pose of each image and a zero vector of the same size.

It penalizes deviation of the refined pose from the original pose.

The GCC regularizer loss is derived as a sum of losses between the color correction matrix of each image and a truncated identity matrix.

It penalizes excessive changes in the color and brightness of the input image.

Performance may be adjusted by setting different weights for each loss, and an example of weight application may be summarized as in Equation 8 below:

$${λ}_{gradient} = 0.3 , {λ}_{depth} = 1. , {λ}_{anchor} = 1. , \qquad [ Equation 8 ]$$

$${λ}_{rot . reg .} = {10}^{6} , {λ}_{trans . reg .} = 10. , {λ}_{gcc . reg .} = {10}^{5}$$

In Equation 8, weight application is exemplified, and the weights may be applied in Equation 7.

For computational efficiency, the input image is down-sampled to ¼ size and used for splatting, and a small resolution of the panoramic image is utilized.

An average of color/gradient/depth images splatted into the panoramic image space may be visualized according to optimization iterations.

It can be seen that in the image 400 corresponding to an initial stage of optimization (iter: 40), an average image is blurry because the splatted images are not well aligned due to inaccurate camera poses; however, as iterations proceed (140→280) as shown in the image 401 and the image 402, it can be observed that the average image becomes clearer as matching is achieved.

In addition, it can be observed that brightness and tone of the images change evenly due to GCC.

The present disclosure achieves alignment through 3D image splatting using depth and camera pose optimization, rather than a method of simply distorting images to reduce stitching errors.

Through this, the present disclosure generates a panorama that is geometrically accurate (enabling XR applications) and has few stitching errors without additional image distortion.

FIGS. 5A and 5B are diagrams illustrating a configuration of frame selection-based preprocessing and local color correction for generating a 360-degree panoramic image according to an embodiment of the present disclosure.

FIG. 5A illustrates a configuration of frame selection-based preprocessing for generating a 360-degree panoramic image according to an embodiment of the present disclosure.

Referring to FIG. 5A, input images are splatted once again into a panoramic image space by applying refined camera poses and GCC.

Additionally, when splatting N images, minimum and maximum inverse depths (wₘᵢₙ, wₘₐₓ) are recorded for each panoramic pixel.

Unlike the previous use of down-sampled images, since this step generates a final panorama result, original input images are used, and a resolution of the panorama subject to splatting is also set to a high resolution to maximally preserve high-frequency details.

In the best frame selection related to an image 500 and an image 510, there may be a plurality of splatting images contributing to each panoramic pixel.

Among them, one image is selected at a time to retrieve a pixel value.

In this case, the panorama processor back-projects the minimum and maximum inverse depths into 3D points.

By projecting the two 3D points onto candidate images, distances between the two points in each image are measured.

An image having the shortest distance is selected as an optimal image.

The meaning of this distance represents a length of a line on each image that corresponds to a given depth uncertainty.

This length represents how many pixels in the corresponding image can be involved with respect to the corresponding panoramic pixel.

Therefore, selecting an image with a short distance to take a pixel value may be considered to have a higher expected value that the corresponding pixel value is true.

A panoramic color image obtained through initial stitching and an index of the used optimal image may be exemplified as in the image 510.

Although GCC is applied in advance as in the image 510, differences in brightness and color tone between stitched images are significant, but the differences are resolved through subsequent additional correction.

FIG. 5B illustrates a configuration of frame selection-based local color correction for generating a 360-degree panoramic image according to an embodiment of the present disclosure.

Referring to FIG. 5B, an image 520 and an image 530 are compared to show correction of color differences between splatting images stitched through the preprocessing process described in FIG. 5A.

Contrasting a portion 521 of the image 520 with a portion 531 of the image 530, it can be confirmed that a more evenly changed image is provided by locally color-correcting each patch image.

A portion selected through the preprocessing process of selecting a best frame from among respective splatting images is only a part.

Hereinafter, a result extracted by dilating these portions by only 1 pixel each will be referred to as a patch image.

As a result of the dilation, adjacent patch images have an overlap of approximately 2 pixels.

The following optimization of locally correcting color of each patch image is performed so as to minimize a difference in an overlap area between patch images.

Here, a method of representing the local color correction is polynomial fitting.

For each patch image, color variations (dr, dg, db) according to pixel coordinates are modeled as a polynomial function, and variables in this case become polynomial coefficients.

Characteristically, due to the nature of the panoramic image currently being handled, a horizontal wrap-around representation is impossible if a monomial is constructed simply using u, v coordinates.

Therefore, in the present disclosure, u and v are first transformed into θ and φ of a panorama projection model, and then the three values (sin (θ), cos (θ) and φ) are used; however, monomials are constructed such that sin (θ) and cos (θ) are not used simultaneously, thereby naturally handling a curved part as exemplified below.

$$1 , sin ( θ ) , cos ( θ ) , ϕ , {sin ( θ )}^{2} , {cos ( θ )}^{2} , {ϕ}^{2} , sin ( θ ) ϕ , cos ( θ ) ϕ , \\ {sin ( θ )}^{3} , {cos ( θ )}^{3} , {ϕ}^{3} , {sin ( θ )}^{2} ϕ , {cos ( θ )}^{2} ϕ , sin ( θ ) {ϕ}^{2} , cos ( θ ) {ϕ}^{2} , \qquad Ex )$$

Through this, assuming that a polynomial coefficient vector of one patch image is C and coordinates of a pixel to be corrected are (u, v)→(θ, φ), a changed color may be summarized as in Equation 9 below:

$${I}_{residual} = tanh ( C \cdot M ) \qquad [ Equation 9 ]$$

$${I}_{corrected} = I + {I}_{residual}$$

In Equation 9, C represents a polynomial coefficient vector, M may represent a monomial vector derived from monomial θ and φ, and variables of optimization may be a set of polynomial coefficients for each patch image.

A loss function related to this may be summarized as in Equation 10 below:

$${L}_{total} = {L}_{overlap} + {λ}_{reg} {L}_{reg} \qquad [ Equation 10 ]$$

In Equation 10, Lₒᵥₑᵣₗₐₚ represents a sum of L2 losses between corrected colors measured in an overlap area between patch images, and serves to reduce differences between adjacent images.

L_{reg} may represent a sum of L1 losses between a color variation vector and a zero vector of the same size, and penalizes excessive deviation from the original color.

λ_{reg} represents a weight, 10⁻³ may be exemplified, and a polynomial order of 3 may be used.

When the polynomial coefficients for each patch image, optimized utilizing only the overlap area, are applied to all remaining areas, the LCC process is completed.

Considering that a resolution of images currently generally used is 8K, optimization may be effectively performed using only the overlap area between patch images while utilizing polynomial fitting.

Due to a smooth characteristic of a low-order polynomial function, a local color correction effect may be naturally achieved even in the remaining areas.

FIG. 6 is a diagram illustrating a seam blending configuration for generating a 360-degree panoramic image according to an embodiment of the present disclosure.

FIG. 6 illustrates an application result of the seam blending configuration for generating a 360-degree panoramic image according to an embodiment of the present disclosure.

Referring to FIG. 6, images 600 and 610 are obtained by cropping only a left portion based on the same panoramic scene, and it can be confirmed that correction is well performed in the image 610 compared to the image 600.

It can be seen that a seam is noticeable in a vertical direction in the image 600, but the corresponding part is not observed in the image 610.

Seam blending is a process of performing additional correction as boundary parts between patch images may be noticeable even after LCC. A loss function may be applied by extracting gradients of respective patch images in advance during a preprocessing process and then guiding gradients calculated from corrected colors to become similar to the original ones.

For example, it may be a correction that prevents color changes from increasing with respect to a sum of losses between pre-extracted color gradient values and current gradient values, and a sum of losses regarding color variation amounts.

FIG. 7 is a diagram illustrating a panorama inpainting configuration related to a 360-degree panoramic image application according to an embodiment of the present disclosure. FIG. 7 illustrates an implementation result based on the panorama inpainting configuration related to the 360-degree panoramic image application according to an embodiment of the present disclosure.

Referring to FIG. 7, panorama inpainting may be implemented from an image 700 to an image 710.

The conversion from the image 700 to the image 710 is implemented by deleting a specific object through inpainting that excludes the specific object as a result of providing a function such as “furniture removal” when implementing augmented reality on a panorama application.

When implementing from the image 700 to the image 710, room layout data representing structures, such as walls and floors, in a mesh form or a plane form is utilized. Such data is obtained through a room plan API during AR shooting or obtained by processing AR planes.

It may be implemented in a manner of orthogonally projecting a texture of the panoramic image onto each plane, performing inpainting on a part detected as a foreground area, and then bringing it back to the panoramic image space.

Accordingly, the present disclosure may achieve natural image implementation in a panoramic area by deleting some internal components and then inpainting the same in an application program implementation for generating a 360-degree panoramic image.

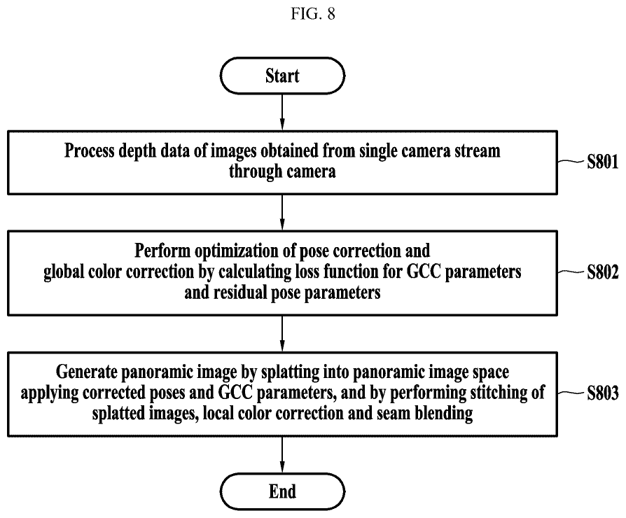

FIG. 8 is a diagram illustrating a method of generating a 360-degree panoramic image according to an embodiment of the present disclosure.

FIG. 8 illustrates a procedure in which the method of generating a 360-degree panoramic image according to an embodiment of the present disclosure achieves alignment of a 360-degree panoramic image through 3D image splatting using depth and camera pose optimization.

Referring to FIG. 8, in step S801, the method of generating a 360-degree panoramic image according to an embodiment of the present disclosure processes depth data of images obtained from a single camera stream through a camera.

That is, the method of generating a 360-degree panoramic image according to an embodiment of the present disclosure processes resolution-related sampling for depth data of images obtained from a single camera stream through a camera by utilizing color images, and constructs a depth map based on a deep learning model.

In step S802, the method of generating a 360-degree panoramic image according to an embodiment of the present disclosure performs optimization of pose correction and global color correction by calculating a loss function for GCC parameters and residual pose parameters.

That is, the method of generating a 360-degree panoramic image according to an embodiment of the present disclosure may determine a virtual panoramic viewpoint considering different camera poses of images, splat the images into a panoramic image space based on a depth map of each of the images, derive Global Color Correction (GCC) parameters related to color value correction of the splatted images and residual pose parameters related to a pose variation amount, calculate at least one loss function for the splatted images, and correct the GCC parameters and the residual pose parameters.

In step S803, the method of generating a 360-degree panoramic image according to an embodiment of the present disclosure performs splatting into the panoramic image space by applying the corrected poses and GCC parameters, and performs stitching of the splatted images, local color correction, and seam blending to generate a panoramic image.

That is, the method of generating a 360-degree panoramic image according to an embodiment of the present disclosure may splat again the images, to which the corrected GCC parameters and the corrected residual pose parameters are applied, into the panoramic image space, stitch the re-splatted images, perform local color correction on overlapping areas in the stitched images, and perform seam blending to generate a panoramic image.

Therefore, the present disclosure may provide an apparatus for generating a 360-degree panoramic image which generates a 360-degree panoramic image by shooting with a mobile phone, which is a general user terminal, without special equipment such as a 360-degree camera, and a method thereof.

The present disclosure can provide an apparatus for generating a 360-degree panoramic image to achieve alignment of a 360-degree panoramic image through 3D image splatting using depth and camera pose optimization and a method thereof.

By achieving alignment of a 360-degree panoramic image, the present disclosure can generate a panoramic image with secured physical accuracy which is capable of measuring a size of a space or implementing an experience such as Augmented Reality (AR).

The present disclosure can provide an apparatus for generating a 360-degree panoramic image which can generate a 360-degree panoramic image by shooting with a mobile phone, which is a general user terminal, without special equipment such as a 360-degree camera, and a method thereof.

The present disclosure can achieve natural image implementation in a panoramic area by deleting some internal components and then inpainting the same in an application program implementation for generating a 360-degree panoramic image.

The apparatus described above may be implemented as a hardware component, a software component, and/or a combination of hardware components and software components. For example, the apparatus and components described in the embodiments may be achieved using one or more general purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device may execute an operating system (OS) and one or more software applications executing on the operating system. In addition, the processing device may access, store, manipulate, process, and generate data in response to execution of the software. For ease of understanding, the processing apparatus may be described as being used singly, but those skilled in the art will recognize that the processing apparatus may include a plurality of processing elements and/or a plurality of types of processing elements. For example, the processing apparatus may include a plurality of processors or one processor and one controller. Other processing configurations, such as a parallel processor, are also possible.

The software may include computer programs, code, instructions, or a combination of one or more of the foregoing, configure the processing apparatus to operate as desired, or command the processing apparatus, either independently or collectively. In order to be interpreted by a processing device or to provide instructions or data to a processing device, the software and/or data may be embodied permanently or temporarily in any type of a machine, a component, a physical device, a virtual device, a computer storage medium or device, or a transmission signal wave. The software may be distributed over a networked computer system and stored or executed in a distributed manner. The software and data may be stored in one or more computer-readable recording media.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

What is claimed is:

1. An apparatus for generating a 360-degree panoramic image, the apparatus comprising:
a depth data processor configured to process resolution-related sampling using a color image for depth data of images acquired from a single camera stream through a camera, and construct a depth map based on a deep learning model;
an error correction processor configured to determine a virtual panoramic viewpoint considering different camera poses of the images, splat the images into a panoramic image space based on the depth map of each of the images, derive a Global Color Correction (GCC) parameter, related to color value correction of the splatted images, and a residual pose parameter related to a pose variation amount, and correct the GCC parameter and the residual pose parameter by calculating at least one loss function for the splatted images; and
a panorama processor configured to re-splat images, to which corrected GCC parameter and the corrected residual pose parameter are applied, into the panoramic image space; stitch the re-splatted images, perform local color correction on overlapping regions in the stitched images, and perform seam blending to generate a panoramic image.

2. The apparatus according to claim 1, wherein the error correction processor back-projects a pixel of each of the images into a 3D point based on the depth map, transforms the 3D point from an image coordinate system to a world coordinate system and from the world coordinate system to a panoramic coordinate system, projects the 3D point into the panoramic image space to calculate coordinates, maps the pixel to a panorama pixel, and splats the images into the panoramic image space based on the calculated pixel mapping.

3. The apparatus according to claim 1, wherein the error correction processor calculates at least one loss function among a photometric consistency loss, a gradient consistency loss, a depth consistency loss, and a feature anchoring loss in relation to the GCC parameter with respect to the splatted images, and calculates at least one loss function among a rotation regularizer loss, a translation regularizer loss, and a GCC regularizer loss in relation to the residual pose parameter.

4. The apparatus according to claim 3, wherein the error correction processor calculates a total loss based on a sum of the at least one loss function, and corrects the GCC parameter and the residual pose parameter by setting a weight for each of the at least one loss function such that the calculated total loss is minimized.

5. The apparatus according to claim 3, wherein the error correction processor calculates the photometric consistency loss based on a sum of losses relative to individual color values after calculating an average color value for all pixels where the splatted images overlap each other on the panoramic image space; calculates the gradient consistency loss based on a sum of losses relative to individual gradient values after deriving gradient images for the images to splat the gradient images, and then calculating an average gradient value for all pixels overlapping each other; calculates the depth consistency loss based on a sum of losses relative to individual values after calculating an average depth value using a reciprocal of a distance calculated when projecting back-projected 3D points into the panoramic image space; and calculates the feature anchoring loss based on feature extraction and matching.

6. The apparatus according to claim 3, wherein the error correction processor calculates the rotation regularizer loss based on a sum of losses between a rotation matrix of a residual pose of each of the images and an identity matrix; calculates the translation regularizer loss based on a sum of losses between a translation vector of the residual pose of each of the images and a zero vector; and calculates the GCC regularizer loss based on a sum of losses between a color correction matrix of each of the images and a truncated identity matrix.

7. The apparatus according to claim 1, wherein the panorama processor derives a pixel value for the splatted images, measures a depth of 3D points for the derived pixel value, selects images to be used for the generated panoramic image from among the splatted images based on the measured depth, and performs the local color correction to correct a color difference for an overlapping area in the selected images.

8. The apparatus according to claim 1, wherein the panorama processor performs the seam blending to correct a color difference for a boundary part within the generated panoramic image by correcting a color, which has been corrected after the local color correction, using a residual color related to a gradient of the image.

9. The apparatus according to claim 1, further comprising an application processor configured to select at least one object in the panoramic image, delete the selected at least one object to process it into an Augmented Reality (AR) plane, and restore the processed AR plane into the panoramic image.

10. The apparatus according to claim 9, wherein the application processor performs processing into the AR plane by performing orthographic projection of a texture of the panoramic image onto each plane and then performing inpainting on a part detected as a foreground area in each plane.

11. A method of generating a 360-degree panoramic image, the method comprising:
by a depth data processor, processing resolution-related sampling using a color image for depth data of images acquired from a single camera stream through a camera, and constructing a depth map based on a deep learning model;
by an error correction processor, determining a virtual panoramic viewpoint considering different camera poses of the images, splatting the images into a panoramic image space based on the depth map of each of the images, deriving a Global Color Correction (GCC) parameter, related to color value correction of the splatted images, and a residual pose parameter related to a pose variation amount, and correcting the GCC parameter and the residual pose parameter by calculating at least one loss function for the splatted images; and
by a panorama processor, re-splatting images, to which corrected GCC parameter and the corrected residual pose parameter are applied, into the panoramic image space; stitching the re-splatted images, performing local color correction on overlapping regions in the stitched images, and performing seam blending to generate a panoramic image.

12. The method according to claim 11, wherein the determining of a virtual panoramic viewpoint considering different camera poses of the images, the splatting of the images into a panoramic image space based on the depth map of each of the images, the deriving of a Global Color Correction (GCC) parameter, related to color value correction of the splatted images, and a residual pose parameter related to a pose variation amount, and the correcting of the GCC parameter and the residual pose parameter by calculating at least one loss function for the splatted images, by the error correction processor comprise:
back-projecting a pixel of each of the images into a 3D point based on the depth map, transforming the 3D point from an image coordinate system to a world coordinate system and from the world coordinate system to a panoramic coordinate system, projecting the 3D point into the panoramic image space to calculate coordinates to map the pixel to a panorama pixel, and splatting the images into the panoramic image space based on the calculated pixel mapping;
calculating at least one loss function among a photometric consistency loss, a gradient consistency loss, a depth consistency loss, and a feature anchoring loss in relation to the GCC parameter with respect to the splatted images, and calculating at least one loss function among a rotation regularizer loss, a translation regularizer loss, and a GCC regularizer loss in relation to the residual pose parameter; and
calculating a total loss based on a sum of the at least one loss function, and correcting the GCC parameter and the residual pose parameter by setting a weight for each of the at least one loss function such that the calculated total loss is minimized.

13. The method according to claim 12, wherein the calculating of at least one loss function among a photometric consistency loss, a gradient consistency loss, a depth consistency loss, and a feature anchoring loss in relation to the GCC parameter with respect to the splatted images, and the calculating of at least one loss function among a rotation regularizer loss, a translation regularizer loss, and a GCC regularizer loss in relation to the residual pose parameter comprise:
calculating the photometric consistency loss based on a sum of losses relative to individual color values after calculating an average color value for all pixels where the splatted images overlap each other on the panoramic image space;
calculating the gradient consistency loss based on a sum of losses relative to individual gradient values after deriving gradient images for the images to splat the gradient images, and then calculating an average gradient value for all pixels overlapping each other;
calculating the depth consistency loss based on a sum of losses relative to individual values after calculating an average depth value using a reciprocal of a distance calculated when projecting back-projected 3D points into the panoramic image space; and
calculating the feature anchoring loss based on feature extraction and matching.

14. The method according to claim 12, wherein the calculating of at least one loss function among a photometric consistency loss, a gradient consistency loss, a depth consistency loss, and a feature anchoring loss in relation to the GCC parameter with respect to the splatted images, and the calculating of at least one loss function among a rotation regularizer loss, a translation regularizer loss, and a GCC regularizer loss in relation to the residual pose parameter comprise:
calculating the rotation regularizer loss based on a sum of losses between a rotation matrix of a residual pose of each of the images and an identity matrix;
calculating the translation regularizer loss based on a sum of losses between a translation vector of a residual pose of each of the images and a zero vector; and
calculating the GCC regularizer loss based on a sum of losses between a color correction matrix of each of the images and a truncated identity matrix.

15. The method according to claim 11, wherein the re-splatting of images, to which corrected GCC parameter and the corrected residual pose parameter are applied, into the panoramic image space; the stitching of the re-splatted images, the performing of local color correction on overlapping regions in the stitched images, and the performing of seam blending to generate a panoramic image comprises:
deriving a pixel value for the splatted images, measuring a depth of 3D points for the derived pixel value, selecting images, to be used for the generated panoramic image, from among the splatted images based on the measured depth, and performing the local color correction to correct a color difference for an overlapping area in the selected images; and
performing the seam blending to correct a color difference for a boundary part within the generated panoramic image by correcting a color, which has been corrected after the local color correction, using a residual color related to a gradient of the image.

16. The method according to claim 11, further comprising: selecting, by an application processor, at least one object in the panoramic image, deleting the selected at least one object to process it into an Augmented Reality (AR) plane, and restoring the processed AR plane into the panoramic image.
